(19) United States
(12) Patent Application Publication
(10) Pub. No.: US 2012/0227276 A1
(43) Pub. Date: Sep. 13, 2012

(54) DUAL PATH KILN IMPROVEMENT

(76) Inventors: Douglas M. Tinsley, Hot Springs, AR (US); Terry R. Freeman, Russellville, AR (US); William S. Smoke, Homer, LA (US); Levi A. Pollard, Appling, GA (US)

(21) Appl. No.: 13/467,137

(22) Filed: May 9, 2012

Related U.S. Application Data
(62) Division of application No. 12/554,165, filed on Sep. 4, 2009, now Pat. No. 8,201,501.

(51) Int. Cl. F26B 25/00; F26B 3/00

(52) U.S. Cl. 34/282

(57) ABSTRACT

A dual path kiln is provided that includes a kiln having one or more chambers and at least two lumber charge paths adapted to convey lumber through the kiln in opposite directions by means of a track having two rails in which a pusher device pushes the lumber through the kiln and comprises a variable output electric motor to effect a high degree of accurate control of the movement speed of the pusher device and the lumber it's pushing and wherein the pusher device includes a faceplate having two side walls extending from said faceplate to engage the side of the lumber in order to greatly enhance stability of the lumber while it is being transported and minimize the risk of spillage.

This is a Divisional Application of U.S. patent application Ser. No. 12/554,165, filed 4 Sep. 2009, the complete disclosure of which is incorporated herein by reference

### FIELD OF THE INVENTION

The present invention relates to the field of lumber handling and more specifically, the present invention is directed to drying equipment for preparing raw lumber for sale. As is well known, fresh cut lumber includes a large quantity of moisture and it has been the practice to subject such lumber to heat treatment to drive off the moisture so that the lumber, as sold, will be less subject to warping or bending during storage or after installation in a structure.

### BACKGROUND

As described in co-pending application U.S. patent application Ser. No. 11/525,929 filed Sep. 25, 2006, now U.S. Pat. No. 7,963,048, issued Jun. 21, 2011, and incorporated by reference herein, in this field, lumber drying was typically performed in a batch process where a quantity of raw moisture laden lumber is piled in one or more stacks and the stacks were moved into a kiln with an insulated chamber through which heated air was moved to effect removal of moisture from the lumber. As will be evident to those skilled in this technology, this was a labor-intensive and time-consuming process which greatly added to the expense of the finished lumber. One of the improvements of the aforementioned application resides in the use of two generally parallel paths for separate continuous drying lines which are moved in opposite directions through a plurality of chambers which are aligned along the separate paths and in communication with one another to increase the efficiency of the drying process. This is accomplished by continuously moving loads of lumber while conserving the heat that builds up in each load as it is continuously moved along one path in the kiln and transferring some of that heat from a load of dried lumber to an incoming load of green lumber moving from the opposite end of the kiln as they pass one another in the kiln. This results in a great economy in the utilization of the heat energy used in the heating zone which is generally centrally located along the two paths.

### SUMMARY OF THE INVENTION

In the present invention, an improvement in the pusher mechanism, or load mover, for each load moved along the separate paths is provided where greater stability is assured for the lumber positioned on the carriages that are pushed on rails by separate pushing devices in which one is provided for each path. In particular, each pusher device is provided with a faceplate that engages the end of the load to be moved into the kiln with the faceplate extending over a significant area of the end of the load. Further, to allow increased speeds, the faceplate has extending arms to engage the sides of the end load to guard against any wobbling of the load such as may occur upon initiation of movement of the loads through the kiln chambers.

With this arrangement, increased speeds of transport of the loads along each path can be accomplished while minimizing the risks of accidental dislodgment of the load of stacked lumber from the carriage which could greatly diminish the efficiency of the drying process. To ensure stability, an improved pusher device is also provided with a smooth drive mechanism which will decrease the chances of spillage of the load of stacked lumber during the drying process.

### BRIEF DESCRIPTION OF THE DRAWINGS

The operation and advantages of the present invention will become apparent as consideration is given to the following detailed description in conjunction with the accompanying drawings, in which

FIG. 1 is a perspective view of an improved continuous kiln arrangement;

FIG. 2 is in end view in elevation of the continuous kiln arrangement of FIG. 1;

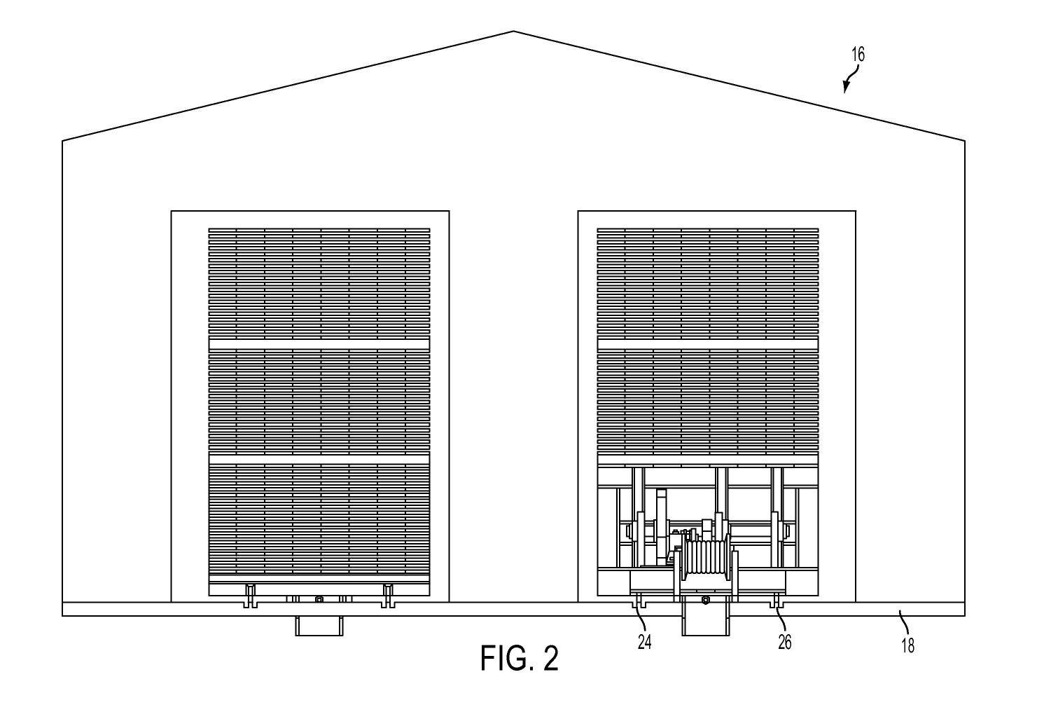

FIG. 3 is a perspective view of one form of the pusher device of the present invention;

FIG. 4 is a perspective view of another embodiment of the pusher device of the present invention;

FIG. 5 a top plan view of the arrangement of FIG. 4; and

FIG. 6 is a side view of the pusher devise of the present invention.

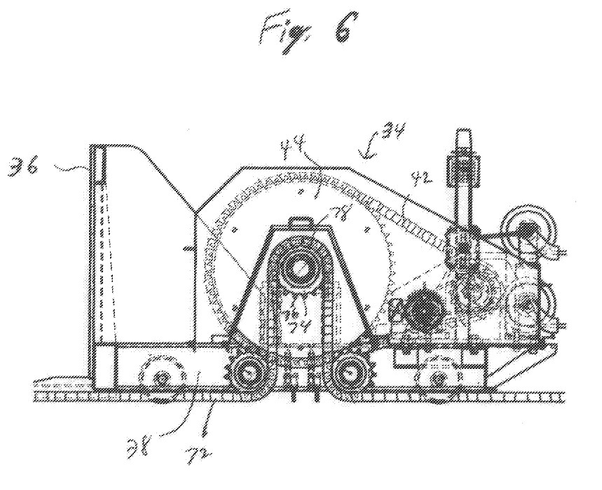

### DETAILED DESCRIPTION

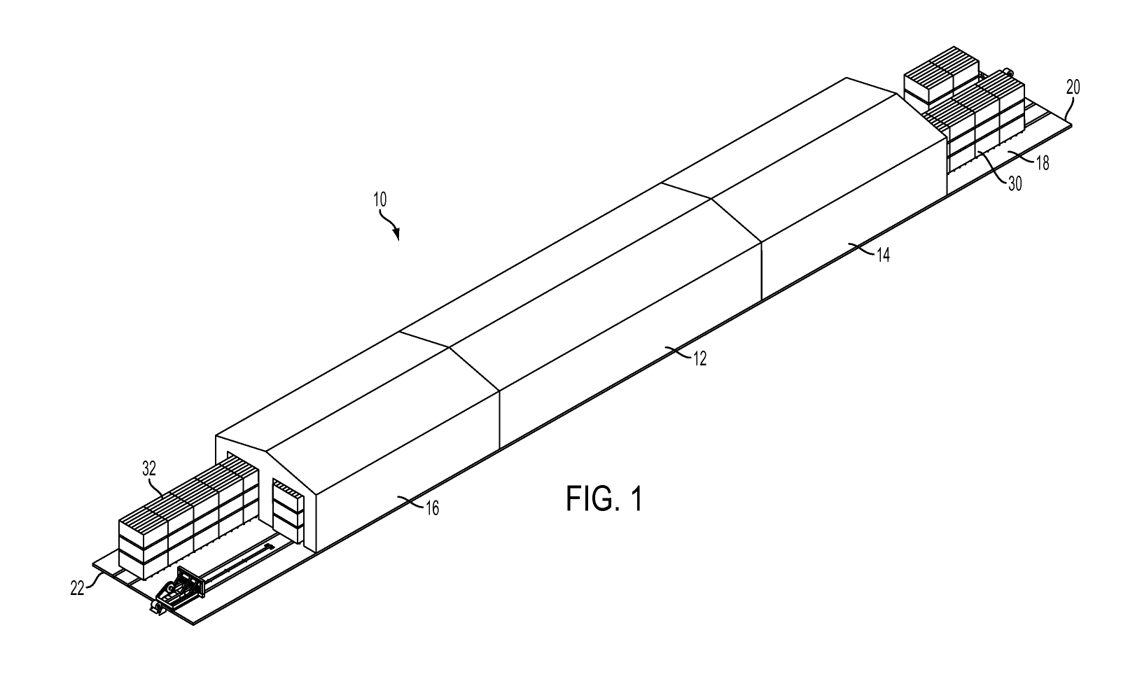

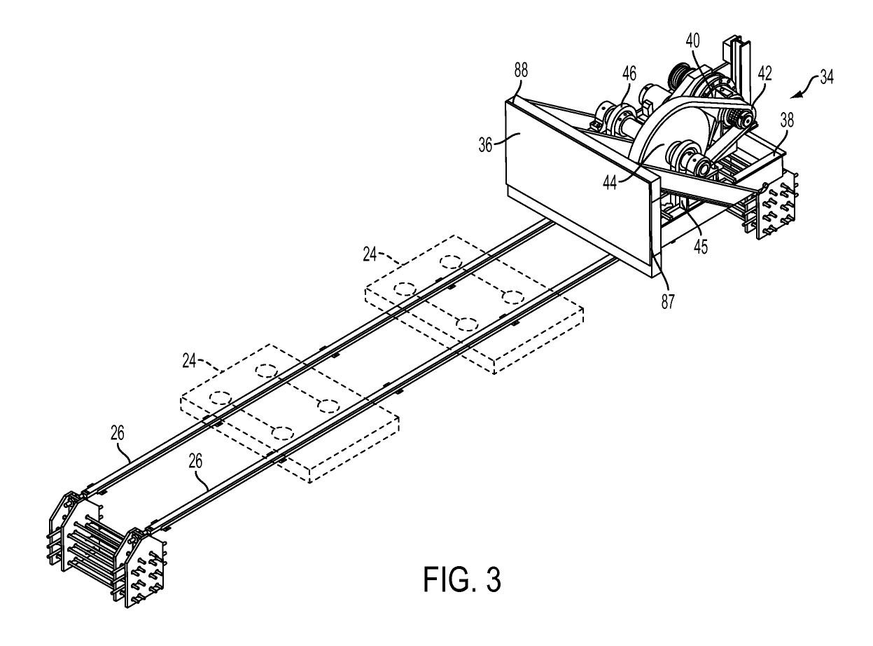

Referring to the non-limiting Figures wherein like numerals designate corresponding parts throughout the various views, there is shown, in FIG. 1, a continuous kiln which typically will include a main heating chamber 12 and opposite end chambers 14 and 16 where heat transfer between the paths will take place aided typically by fans positioned to transfer heat between the passing loads of lumber as they are moved past one another. The base of the kiln 10 may be extended from an entry 22 located at opposite ends of the structure through the chambers 12, 14 and 16 and may include two pairs of parallel rails for each path. As shown in broken lines in FIG. 3, carriages 24 having wheels for engaging the rails 26 are provided and on which the loads of lumber 30, 32 are loaded at the opposite ends 20 and 22 of the base 18. In a typical arrangement, one end of a load of boards will be stacked on the forward carriage 24 while the rear end of the load of boards will rest on the trailing carriage 24 and in a large establishment, a plurality of carriages may be utilized to allow the operator of the kiln to fully occupy all three chambers of the kiln in a continuous drying operation. Alternatively, the pulley 44 transfers power to a single drive gear 74 that can be used to engage a track that is parallel with the rails 26. An example of the track is the chain 72. The drive gear 74 has teeth 76 which engage openings 78 in the links in the chain 72.

For small, and therefore relatively stable loads, a pusher device 34 will include a flat vertical plate 36 mounted in the front of a housing 38. The housing 38 is preferably an open frame and may be rectangular in shape and have one or more transverse support struts for supporting an electric motor 40 having an output connected through a belt or chain 42 to transmit rotary motion to a large wheel 44 which in turn rotates an axle rotatably mounted on supports one of which is shown at 45. This will transmit motion to the axle which in turn rotates pulleys one of which is shown at 46. With this arrangement, the pulleys 46 will transmit rotary motion to a pair of gears which will engage a link chain 72 mounted on the housing 38 between the rails 26. The pair of gears including a periphery from which teeth extend radially which are sized to each fit in openings in the links of the chain 72. Thus, with a variable output electric motor 40 mounted on the housing 38, a high degree of accurate control of the movement speed of the housing 38 and faceplate 36 can be obtained.

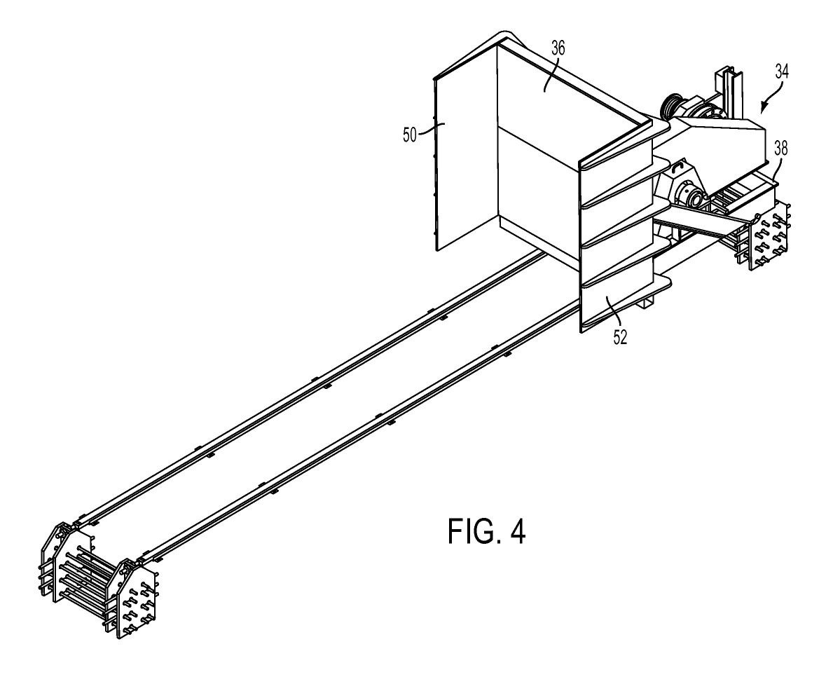

With larger loads and kiln structures having a greater capacity, more stability is needed in the transport of the loads of lumber to be kiln dried. According to the present invention this is achieved by the structure shown in FIG. 4 where the plate 36, having a first and a second end 88 and 87, is modified to include side plates 50 and 52 which extend horizontally from the plate's first and second ends 88 and 87 respectively such that said side plates 50 and 52 will engage a portion of the side of the loads carried on a carriage 24. The side plates may be of a vertical extent to engage substantially the full height of the load to be mounted on the carriages 24. The stability of the transportation function is therefore greatly enhanced and the risk of spillage of the load is minimized. It will be understood that the plates 50 and 52 may be perforated to allow free circulation of air at the end portions of the loads to assure even curing of the lumber in engagement with the plate 36 of the pusher device 34.

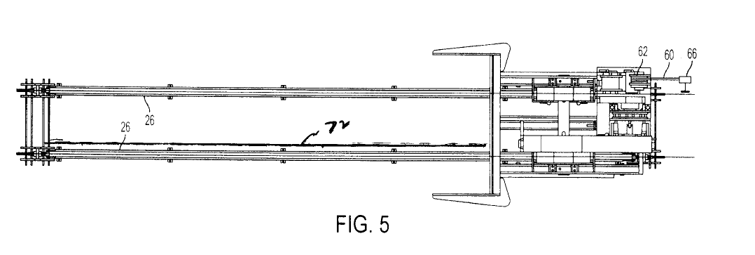

As noted above, the use and of the electric motor 40 to effect movement of the housing 38 has the advantage that such motors can be of the variable speed type thus allowing close control of the speed of movement of the carriages and loads of lumber. Further, electrical power can be supplied through a cable 60 which is unwound from a spool 62 rotatably mounted on the top of the housing 38 as shown in FIG. 5. One end of the cable 60 is connected to the electric motor 40 and the opposite end of the cable 60 is connected to a current source 66 wherein a portion of the cable 60 is carried on the spool 62 which is resiliently urged to maintain tension on the cable. The rotation of the axle mounted pulleys 46 will be transmitted directly to drive gears which are rotatably mounted on the underside of the housing 38 and which preferably separately engage a sprocket chain at spaced apart positions where the sprocket chain is anchored to the base 18 and extends the full length of the paths of travel of the lumber to be dried.

While the claimed invention has been described in detail and with reference to specific embodiments thereof, it will be apparent to one of ordinary skill in the art that various changes and modifications can be made to the claimed invention without departing from the spirit and scope thereof.

1-9. (canceled)

10. A method of drying lumber in a continuous kiln having at least three chambers arranged serially from one end of the kiln to the opposite end with the ends being open to allow the passage of a load mover and a load of lumber supported on a carriage, the kiln having a floor and a pair of parallel rails mounted on the floor and extending along a path that extends from outside the kiln through the chambers, the load mover including a housing having a wall with which at least a portion of the load is engageable during transport sequentially through the chambers of the kiln, the housing having wheels that, in use, engage and ride on the rails, the kiln having a track extending parallel to the rails and through the kiln, the track being mounted on the floor, the load mover having mounted thereon a variable speed electric motor and gearing constructed for transferring the output of the motor to a transport gear which is rotatably mounted on the housing of the load mover and which engages the track so that rotation of the transport gear will effect movement of the load mover on the rails, and the wall having a substantially vertical portion to engage the load supported on the carriage which rides on the rails where the vertical portion is positioned to be moved against the load to enhance the stability of the load during transport along the rails, the method comprising:
providing the load of lumber on the carriage; and
using the electric motor to drive the transport gear engaging the track to move the load mover which pushes the load of lumber on the carriage through the kiln to produce dried lumber.

11. The method according to claim 10, wherein a front end of the load of lumber is supported by a forward carriage and a back end of the load of lumber is supported by a trailing carriage.

12. The method according to claim 10, further comprising a plurality of loads of lumber each being loaded on a respective carriage that fully occupies all three chambers of the kiln, with each successive load being against each other so that when the load mover pushes an end of a new load being moved into the kiln the new load pushes the previous loads through the kiln.

13. The method according to claim 10, wherein the track is a chain having links each of which provides an opening and the transport gear includes a periphery from which teeth extend radially and which are sized to each fit in the opening in the links of the chain.

14. The method according to claim 10, wherein the housing comprises a front side and a rear side with the motor being mounted adjacent the rear side and the load engaging portion of the wall being located adjacent the front side.

15. The method according to claim 14, further comprising supplying electricity to the electric motor using a flexible conduit having one end connectable to the motor and an opposite end connectable to a source of current, a portion of the conduit being carried on a spindle that is resiliently urged to maintain tension on the conduit.

16. The method according to claim 13, wherein the housing rotatably supports another transport gear spaced from the first mentioned transport gear with both of the spaced apart gears being driven by the motor and gearing.

17. The method according to claim 17, wherein the spaced apart gears both engage the chain at spaced apart positions.

18. A method of drying lumber in a continuous kiln having at least three chambers arranged serially from one end of the kiln to the opposite end with the ends being open to allow the passage of a load mover and a load of lumber supported on a carriage, the kiln having a floor and a pair of parallel rails mounted on the floor and extending along a path that extends from outside the kiln through the chambers, the load mover including a housing having a wall with which at least a portion of the load is engageable for transport sequentially through the chambers of the kiln, the housing having wheels that, in use, engage and ride on the rails, the kiln having a track extending parallel to the rails and through the kiln, the track being mounted on the floor, the load mover having mounted thereon a variable output electric motor and gearing constructed for transferring the output of the motor to a transport gear which is rotatably mounted on the housing of the load mover and which engages the track so that rotation of the transport gear will effect movement of the load mover on the rails, and the wall having a substantially vertical portion to engage the load supported on the carriage which rides on the rails where the vertical portion is positioned to be moved against the load to enhance the stability of the load during transport along the rails, the wall having a first end and a second end wherein a first and a second sidewall each extends horizontally from the wall's first and second ends respectively, the method comprising:
providing the load of lumber on the carriage; and
using the electric motor to drive the transport gear engaging the track to move the load mover which pushes the load of lumber on the carriage through the kiln to produce dried lumber.

19. The method according to claim 18, wherein a front end of the load of lumber is supported by a forward carriage and a back end of the load of lumber is supported by a trailing carriage.

20. The method according to claim 18, further comprising a plurality of loads of lumber each being loaded on a respective carriage that fully occupies all three chambers of the kiln, with each successive load being against each other so that when the load mover pushes an end of a new load being moved into the kiln the new load pushes the previous loads through the kiln.

21. The method according to claim 18, wherein the first and second sidewalls are perforated to allow free circulation of air and even curing of the load.

22. The method according to claim 21, wherein the first and second sidewalls are configured to engage the full height of the load.
